(19) United States
(12) Patent Application Publication
(10) Pub. No.: US 2016/0140444 A1
(43) Pub. Date: May 19, 2016

(54) SYSTEM AND METHOD FOR CONTEXTUAL RECIPE RECOMMENDATION

(71) Applicant: International Business Machines Corporation, Armonk, NY (US)

(72) Inventors: Ashish Jagmohan, Irvington, NY (US); Nan Shao, Ridgefield, CT (US); Anshul Sheopuri, Teaneck, NJ (US); Lav R. Varshney, Champaign, IL (US); Dashun Wang, White Plains, NY (US)

(21) Appl. No.: 14/543,119

(22) Filed: Nov. 17, 2014

(51) Int. Cl. G06N 5/04; H04L 29/08

(52) U.S. Cl. CPC G06N 5/048; H04L 67/22; G06Q 50/01

(57) ABSTRACT

A computing device identifies one or more contextual variables within one or more social media messages. The computing device determines a contextual influence value based on the one or more social media messages. The computing device determines an appetite level. The computing device determines an unadjusted expected value of pleasantness based on the determined contextual influence value and the determined appetite level.

### TECHNICAL FIELD

The present invention relates generally to social networking, and more particularly to utilizing social networks to determine a personalized recipe recommendation.

### BACKGROUND

There are several different factors to creating the perfect meal. Using the right recipe and the freshest ingredients are right at the top of the list. But the recipe is more than just ingredients, it's a particular mix of chemical compounds that blend together to form a delectable treat designed to fit a desired flavor profile. For example, certain compounds mixed together may create a spicy flavor profile, while others may create a savory or sweet and savory profile. However, determining the right chemical compounds for a meal is universal. Other factors may be utilized in order to personalize a recipe for a specific person or group of people.

### SUMMARY

In one aspect, the present invention provides a method for providing a food recommendation. A computing device identifies one or more contextual variables within one or more social media messages. The computing device determines a contextual influence value based on the one or more social media messages. The computing device determines an appetite level. The computing device determines an unadjusted expected value of pleasantness based on the determined contextual influence value and the determined appetite level.

### BRIEF DESCRIPTION OF THE DRAWINGS

FIG. 1 illustrates an individualized pleasantness identification system, in accordance with an embodiment of the invention.

FIG. 2 is a flowchart illustrating the operations of the pleasantness program of FIG. 1 in determining an adjusted pleasantness value and creating a food recommendation, in accordance with an embodiment of the invention.

FIG. 3 is a block diagram depicting the hardware components of the individualized pleasantness identification system of FIG. 1, in accordance with an embodiment of the invention.

### DETAILED DESCRIPTION

Embodiments of the present invention will now be described in detail with reference to the accompanying Figures.

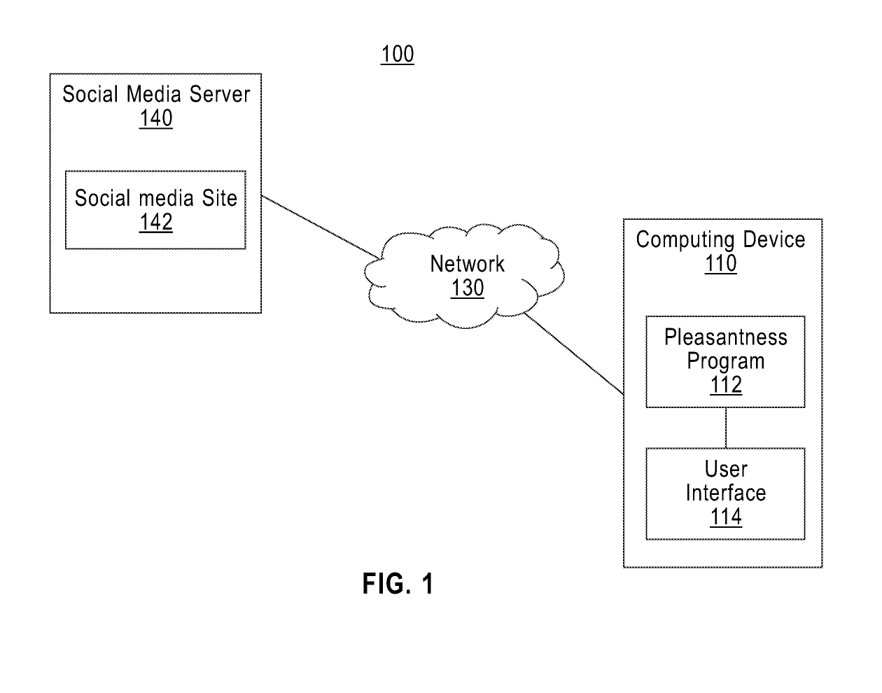

FIG. 1 illustrates individualized pleasantness identification system 100, in accordance with an embodiment of the invention. In an exemplary embodiment, individualized pleasantness identification system 100 includes computing device 110 and social media server 140 all interconnected via network 130.

In the example embodiment, network 130 is the Internet, representing a worldwide collection of networks and gateways to support communications between devices connected to the Internet. Network 130 may include, for example, wired, wireless, or fiber optic connections. In other embodiments, network 130 may be implemented as an intranet, a local area network (LAN), or a wide area network (WAN). In general, network 130 can be any combination of connections and protocols that will support communications between computing device 110 and social media server 140.

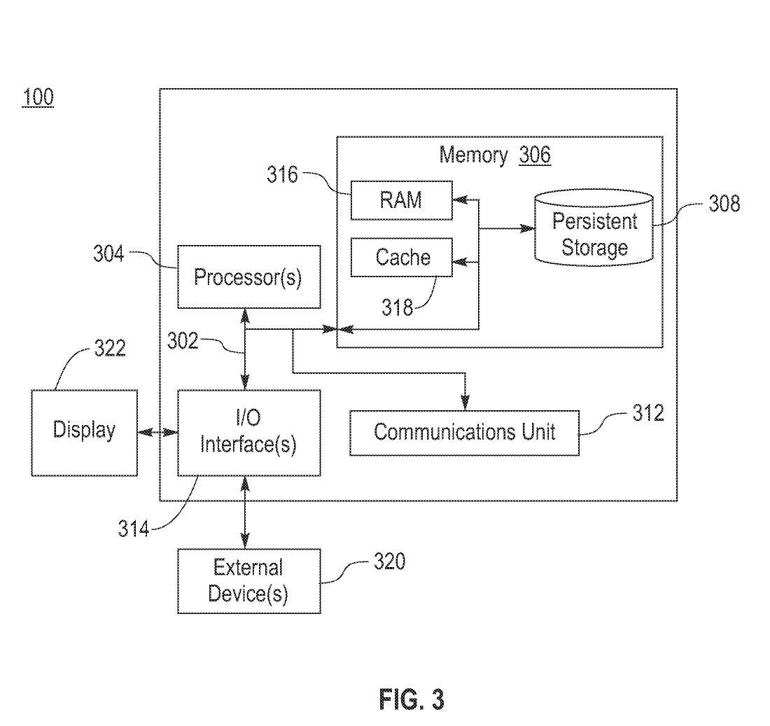

Social media server 140 includes social media site 142. Social media server 140 may be a desktop computer, a notebook, a laptop computer, a tablet computer, a handheld device, a smart-phone, a thin client, or any other electronic device or computing system capable of receiving and sending data to and from other computing devices such as computing device 110 via network 130. Although not shown, optionally, social media server 140 can comprise a cluster of web servers executing the same software to collectively process the requests for the web pages as distributed by a front end server and a load balancer. In the example embodiment, social media server 140 is a computing device that is optimized for the support of websites which reside on social media server 140, such as social media site 142, and for the support of network requests related to websites, which reside on social media server 140. Social media server 140 is described in more detail with reference to FIG. 3.

Social media site 142 is a collection of files including, for example, HTML files, CSS files, image files and JavaScript files. Social media site 142 can also include other resources such as audio files and video files.

Computing device 110 includes pleasantness program 112 and user interface 114. Computing device 110 may be a desktop computer, a notebook, a laptop computer, a tablet computer, a handheld device, a smart-phone, a thin client, or any other electronic device or computing system capable of receiving and sending data to and from other computing devices, such as social media server 140, via network 130. Although not shown, optionally, computing device 110 can comprise a cluster of web devices executing the same software to collectively process requests. Computing device 110 is described in more detail with reference to FIG. 3.

User interface 114 includes components used to receive input from a user and transmit the input to an application residing on computing device 110. In the example embodiment, user interface 114 uses a combination of technologies and devices, such as device drivers, to provide a platform to enable users of computing device 110 to interact with pleasantness program 112. In the example embodiment, user interface 114 receives input, such as textual input received from a physical input device, such as a keyboard, via a device driver that corresponds to the physical input device.

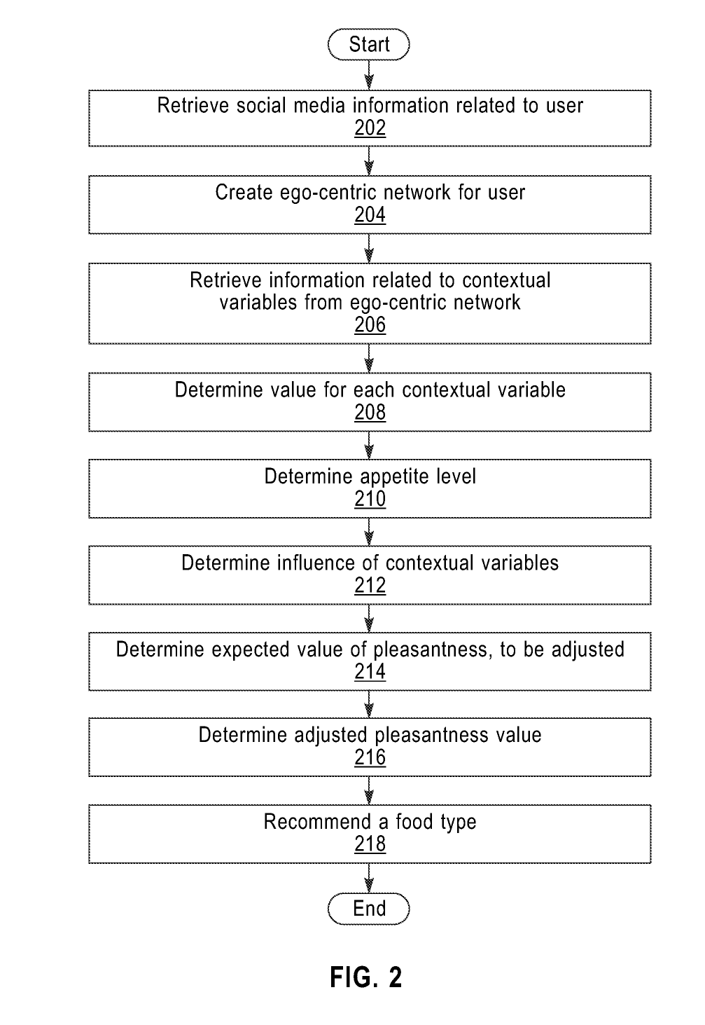

Pleasantness program 112 is software capable of receiving information, such as social media messages from social media server 140 via network 130, and determining one or more individualized pleasantness values based on the received information. In addition, in the example embodiment, pleasantness program 112 is capable of providing a recommendation, such as a food recommendation, to a user based on the individualized pleasantness values. Furthermore, pleasantness program 112 is also capable of utilizing optical character recognition (OCR) and natural language processing in order to identify relevant portions of the received information, such as received social media messages. The operations and functions of pleasantness program 112 is described in more detail with reference to FIG. 2.

FIG. 2 is a flowchart illustrating the operations of pleasantness program 112 in determining an individualized pleasantness value based on received information, in accordance with an exemplary embodiment of the invention. In the example embodiment, pleasantness program 112 retrieves social media information related to the user of computing device 110 from social media server 140 via network 130 (step 202). In the example embodiment, pleasantness program 112 retrieves social media information, such as social media messages, that contain certain keywords, such as restaurant names, types of food, recipes, or other food related terminology.

Pleasantness program 112 then creates an ego-centric network from the retrieved social media information (step 204). In the example embodiment, pleasantness program 112 creates layers from the social media information. For example, the first layer of messages may be the retrieved social media messages authored by the user of computing device 110. The second layer may be the retrieved social media messages authored by friends of the user of computing device 110, while the third layer may be the retrieved social media messages of friends of friends of the user of computing device 110. In the example embodiment, pleasantness program 112 may assign each of these layers a separate weight. For example, the first layer may carry a higher weight than the second and the second a higher weight than the third layer.

Pleasantness program 112 extracts information related to contextual variables from the social media information contained in the ego-centric network (step 206). In the example embodiment, pleasantness program 112 extracts information such as information related to location, emotion, and information related to social activities. In addition, along with extracting information related to contextual variables, pleasantness program 112 extracts information related to the food type.

Pleasantness program 112 then determines a numerical value for each contextual variable (step 208). In the example embodiment, a numerical value may be predetermined by user input, such as a value of 1 for home, or −1 for the office. Regarding the contextual variable emotion, the predetermined value may be 1 for happy, and −1 for unhappy, and regarding the contextual variable social activity, the predetermined value may be 1 for interacting with friends/family, and −1 for alone. In other embodiments, the numerical value for each contextual variable may be another predetermined value or determined by way of utilizing the ego-centric network or social media at large to determine a consensus value for each contextual variable.

Pleasantness program 112 then determines the appetite level of the user of computing device 110 (step 210). In the example embodiment, the appetite level is the level at which the user of computing device 110 feels hunger and is input by the user of computing device 110 via user interface 114. The appetite level may be a yes (+1) or no (−1) value or may be another numerical value such as a value between 1 and 10 with 1 representing the least hunger value and 10 representing the greatest hunger value. In other embodiments, pleasantness program 112 may determine the appetite level of the user of computing device 110 by way of processing of social media messages of the user of computing device 110. For example, pleasantness program 112 may examine recent social media messages to determine the appetite level of the user of computing device 110 or examine prior social media messages to determine specific times at which the user of computing device 110 exhibits hunger or does not exhibit hunger.

Pleasantness program 112 then determines a numerical value for the influence of contextual variables based on the retrieved information (step 212). In the example embodiment, the influence of contextual variables is represented by F. In the example embodiment, F may be defined as −f or f, with −f representing a negative value and f representing a positive value. For example, the food type pizza eaten at home (location—contextual variable) may have a value of f, while the food type salad eaten at work (location—contextual variable) may have a value of −f. In other embodiments, logistic regression of the retrieved social media messages may be used to determine a consensus for each food type plus contextual variable(s). The consensus value may be as simple as a single positive value representing a positive consensus and a single negative value representing a negative consensus or alternatively a value from a range of positive and negative values may be utilized to more precisely depict the influence of contextual variables. In the example embodiment, food type is taken into account when determining F, however, in other embodiments, food type may not be taken into account when determining F. For example, the determined contextual variables may be summed up together and if the sum of the contextual variables is positive, F is 1. If the sum of the contextual variables is negative or 0, F is −1.

Pleasantness program 112 then determines an expected value of pleasantness (to be adjusted) for each food type (step 214). In the example embodiment, the expected value of pleasantness (Eⱼ) for an individual j, to be adjusted, is determined by way of using the equation (equation 1) shown below:

Eⱼ=−f tan h(Bⱼf) (1)
where Bⱼ represents the proxy of hunger and f represents a numerical value of the influence of contextual variables on the expected value of pleasantness (to be adjusted).

Furthermore, Bⱼ is determined by using the equation (equation 2) shown below:

$${B}_{j} = \frac{1}{{k}_{B} {A}_{j}} \qquad ( 2 )$$

In the example embodiment, the expected value of pleasantness (to be adjusted) is determined based on Boltzmann statistics, with k_{B} representing the Boltzmann constant. Therefore, F is viewed as an external field that influences the “state” predicted by g(x), which corresponds to a pleasantness value determined by evaluation of chemical compounds. Aⱼ, the appetite level, is viewed similar to the temperature in a system of particles. At a low temperature, particles do not respond to an external field, whereas at a high temperature, a small external energy is enough to push the particles into an excited state. In the same manner, when a person is not hungry (low appetite level), even a food type with a high pleasantness value will not draw a response from the person, whereas if the person is hungry (high appetite level), a food type even with a relatively low pleasantness value may draw a response from the person. Therefore, the proxy of hunger can be determined by utilizing equation 2 shown above.

In the example embodiment, where F has a binary outcome (−f and f), the partition function, Z, can be defined as:

$$Z = {\sum }_{s} {e}^{- B {f}_{s}} = {e}^{+ Bf} + {e}^{- B f} = 2 cosh ( Bf ) \qquad ( 3 )$$

Thus, the probability of finding the “particle” in either the “excited” or “un-excited” state is:

$$P ↑ = \frac{{e}^{Bf}}{2 cosh ( Bf )} , \\ P ↓ = \frac{{e}^{- Bf}}{2 cosh ( Bf )} \qquad ( 4 )$$

Therefore, based on canonical ensemble, the average “energy”, i.e., expected value of pleasantness (to be adjusted), can be determined by using the equation below:

$$〈 E 〉 = - ( \frac{\partial ln Z}{\partial B} ) = \frac{1}{Z} ( \frac{\partial Z}{\partial B} ) \qquad ( 5 )$$

Plugging equation 3 into equation 5 yields:

$$〈 {E}_{j} 〉 = - \frac{1}{2 cosh ( Bf )} * \frac{\partial 2 cosh ( Bf )}{\partial B} = - f tanh ( {B}_{j} f ) \qquad ( 6 )$$

which is the equation to determine the expected value of pleasantness (to be adjusted) for an individual j, as described in equation 1.

Therefore, after determining F, based on contextual variables, and Bⱼ based on hunger and appetite, pleasantness program 112 is able to determine the expected value of pleasantness (to be adjusted) for an individual j for each food type/recipe.

Pleasantness program 112 then determines the adjusted pleasantness value for each food type (step 216). In the example embodiment, determining the adjusted/individualized pleasantness value for each food type can be determined by utilizing equation 7 as shown below:

Eⱼ(adjusted)=E₃+g (7)
with Eⱼ representing the expected value of pleasantness (to be adjusted) for an individual j and g representing an expected value of pleasantness based on physicochemical properties. In addition, g, is not a measure of individualized pleasantness but rather a general measure since physicochemical properties are utilized in determining the value. Therefore, the value of g for a food item/type would be the same for two different people.

In the example embodiment, g may be determined utilizing a two-step process. First, a linear function of physiochemical properties of each flavor compound may be determined in order to generate the pleasantness value for the specific flavor compound. Examples of physiochemical properties of a flavor compound may include, but are not limited to, a heavy atom count, complexity, a rotatable bond count, and a hydrogen bond acceptor count. A weight may then be assigned to each variable (which corresponds to a physiochemical property), with the weight being determined by using a regression model with the potential data sources from public chemical databases or as described in the following reference (Rafi Haddad, Abebe Medhanie, Yehudah Roth, David Harel, and Noam Sobel. 2010. Predicting Odor Pleasantness with an Electronic Nose. PLoS Comput. Biol. 6, 4 (April 2010), e1000740, which is hereby incorporated by reference in its entirety).

Next, a function is generated, such as a linear combination of constituent flavor compounds in the ingredients of a food/recipe, weighted by the respective intensities of the constituent flavor compounds and weights of the ingredients. The constituent flavor compounds and their intensity in an ingredient may be obtained from data sources such as the following reference (George A. Burdock. Fenaroli's Handbook of Flavor Ingredients. 6^{th} Edition (2010), which is hereby incorporated by reference in its entirety). In the example embodiment, by combining the pleasantness values associated with each flavor compound in the ingredients of the food/recipe, we obtain the pleasantness of the corresponding food/recipe (g).

Pleasantness program 112 then compares the determined adjusted/individualized pleasantness value (Eⱼ(adjusted)) for each food type/recipe and recommends the food/recipe with the best expected value of pleasantness (adjusted) (step 218). In the example embodiment, a higher adjusted/individualized pleasantness value denote a higher level of expected pleasantness, however, in other embodiments, a lower value may correspond to a higher level of expected pleasantness, or an entirely different rating system may be used. Furthermore, in the example embodiment, pleasantness program 112 provides the recommendation via user interface 114. In other embodiments, the user of computing device may also input one or more ingredients or chemical compounds and pleasantness program may provide a recommendation based on the input ingredients/chemical compounds. For example, if the user of computing device 110 inputs kale and radish, pleasantness program 112 may narrow down the food/recipe choices to those which contain kale and radish and then recommend the food/recipe which has the best adjusted/individualized pleasantness value.

The foregoing description of various embodiments of the present invention has been presented for purposes of illustration and description. It is not intended to be exhaustive nor to limit the invention to the precise form disclosed. Many modifications and variations are possible. Such modifications and variations that may be apparent to a person skilled in the art of the invention are intended to be included within the scope of the invention as defined by the accompanying claims.

FIG. 3 depicts a block diagram of components of computing device 110 and social media server 140, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Computing device 110 and social media server 140 include communications fabric 302, which provides communications between computer processor(s) 304, memory 306, persistent storage 308, communications unit 312, and input/output (I/O) interface(s) 314. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 316 and cache memory 318. In general, memory 306 can include any suitable volatile or non-volatile computer-readable storage media.

The programs pleasantness program 112 and user interface 114 in computing device 110; and social media site 142 in social media server 140 are stored in persistent storage 308 for execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 312, in these examples, provides for communications with other data processing systems or devices. In these examples, communications unit 312 includes one or more network interface cards. Communications unit 312 may provide communications through the use of either or both physical and wireless communications links. The programs pleasantness program 112 and user interface 114 in computing device 110, and social media site 142 in social media server 140, may be downloaded to persistent storage 308 through communications unit 312.

I/O interface(s) 614 allows for input and output of data with other devices that may be connected to computing device 110 and social media server 140. For example, I/O interface 314 may provide a connection to external devices 320 such as, a keyboard, keypad, a touch screen, and/or some other suitable input device. External devices 320 can also include portable computer-readable storage media such as, for example, thumb drives, portable optical or magnetic disks, and memory cards. Software and data used to practice embodiments of the present invention, e.g., the programs pleasantness program 112 and user interface 114 in computing device 110, and social media site 142 in social media server 140, can be stored on such portable computer-readable storage media and can be loaded onto persistent storage 308 via I/O interface(s) 314. I/O interface(s) 314 can also connect to a display 322.

Display 322 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge devices. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or device. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for providing a food recommendation, comprising the steps of:
a computing device identifying one or more contextual variables within one or more social media messages;
the computing device determining a contextual influence value based on the one or more social media messages;
the computing device determining an appetite level; and
the computing device determining an unadjusted expected value of pleasantness based on the determined contextual influence value and the determined appetite level.

2. The method of claim 1, further comprising:
the computing device determining an adjusted pleasantness value based on the determined unadjusted expected value of pleasantness and another expected value of pleasantness determined based on physiochemical properties.

3. The method of claim 1, further comprising:
the computing device creating an ego-centric social network that includes at least the one or more social media messages.

4. The method of claim 3, further comprising:
the computing device determining a value for each of the one or more contextual variables based on a consensus value determined by utilizing the ego-centric social network.

5. The method of claim 1, further comprising:
the computing device determining a value for each of the one or more contextual variables based on a user input.

6. The method of claim 1, wherein the appetite level is determined based on user input.

7. The method of claim 1, further comprising:
the computing device assigning a weight to each of the one or more social media messages.

8. A computer program product for providing a food recommendation, the computer program product comprising:
one or more computer-readable storage devices and program instructions stored on at least one of the one or more tangible storage devices, the program instructions comprising:
program instructions to identify one or more contextual variables within one or more social media messages;
program instructions to determine a contextual influence value based on the one or more social media messages;
program instructions to determine an appetite level; and
program instructions to determine an unadjusted expected value of pleasantness based on the determined contextual influence value and the determined appetite level.

9. The computer program product of claim 8, further comprising:
program instructions to determine an adjusted pleasantness value based on the determined unadjusted expected value of pleasantness and another expected value of pleasantness determined based on physiochemical properties.

10. The computer program product of claim 8, further comprising:
program instructions to create an ego-centric social network that includes at least the one or more social media messages.

11. The computer program product of claim 10, further comprising:
program instructions to determine a value for each of the one or more contextual variables based on a consensus value determined by utilizing the ego-centric social network.

12. The computer program product of claim 8, further comprising:
program instructions to determine a value for each of the one or more contextual variables based on a user input.

13. The computer program product of claim 8, wherein the appetite level is determined based on user input.

14. The computer program product of claim 8, further comprising:
program instructions to assign a weight to each of the one or more social media messages.

15. A computer system for providing a food recommendation, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to identify one or more contextual variables within one or more social media messages;
program instructions to determine a contextual influence value based on the one or more social media messages;
program instructions to determine an appetite level; and
program instructions to determine an unadjusted expected value of pleasantness based on the determined contextual influence value and the determined appetite level.

16. The computer system of claim 15, further comprising:
program instructions to determine an adjusted pleasantness value based on the determined unadjusted expected value of pleasantness and another expected value of pleasantness determined based on physiochemical properties.

17. The computer system of claim 15, further comprising:
program instructions to create an ego-centric social network that includes at least the one or more social media messages.

18. The computer system of claim 17, further comprising:
program instructions to determine a value for each of the one or more contextual variables based on a consensus value determined by utilizing the ego-centric social network.

19. The computer system of claim 15, further comprising:
program instructions to determine a value for each of the one or more contextual variables based on a user input.

20. The computer system of claim 15, further comprising:
program instructions to assign a weight to each of the one or more social media messages.
